(19) United States
(12) Patent Application Publication
(10) Pub. No.: US 2024/0386624 A1
(43) Pub. Date: Nov. 21, 2024

(54) EXCHANGEABLE BANDS

(71) Applicant: Apple Inc., Cupertino, CA (US)

(72) Inventors: Muhammad F. HOSSAIN, Sunnyvale, CA (US); Samuel A. RESNICK, San Francisco, CA (US)

(21) Appl. No.: 18/691,860

(22) PCT Filed: Sep. 15, 2022
(86) PCT No.: PCT/US2022/043717

§ 371 Date: Mar. 13, 2024

Related U.S. Application Data
(60) Provisional application No. 63/247,206, filed on Sep. 22, 2021.

(51) Int. Cl. G06T 11/00; G06F 1/16; G06F 3/01; G06K 7/14; G06V 20/20; G06V 20/50

(52) U.S. Cl. CPC G06T 11/00; G06F 1/163; G06F 3/011; G06K 7/1413; G06K 7/1417; G06V 20/20; G06V 20/50

(57) ABSTRACT

Systems of the present disclosure can provide a wearable electronic device with attachable and exchangeable bands that provide a variety of different components and functions to achieve the results that are desired by a user. A selection of a certain band can influence operation of the wearable electronic device in a variety of ways. For example, the wearable electronic device can respond to the identification of a particular band by performing particular functions, such as changing an aspect of a user interface or altering settings of the wearable electronic device. Such functions can be readily executed by the wearable electronic device upon identification of the band, such that user input is not required. Accordingly, a user's experience with the wearable electronic device can be enhanced based on the user's selection of a particular band.

### CROSS-REFERENCE TO RELATED APPLICATION

This application claims the benefit of U.S. Provisional Application No. 63/247,206, entitled “HEAD-MOUNTABLE DEVICES WITH EXCHANGEABLE BANDS,” filed Sep. 22, 2021, the entirety of which is incorporated herein by reference.

### TECHNICAL FIELD

The present description relates generally to head-mountable devices, and, more particularly, to fit guidance for head-mountable devices.

### BACKGROUND

A head-mountable device can be worn by a user to display visual information within the field of view of the user. The head-mountable device can be used as a virtual reality (VR) system, an augmented reality (AR) system, and/or a mixed reality (MR) system. A user may observe outputs provided by the head-mountable device, such as visual information provided on a display. The display can optionally allow a user to observe an environment outside of the head-mountable device. Other outputs provided by the head-mountable device can include speaker output and/or haptic feedback. A user may further interact with the head-mountable device by providing inputs for processing by one or more components of the head-mountable device. For example, the user can provide tactile inputs, voice commands, and other inputs while the device is mounted to the user's head.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a top view of a head-mountable device, according to some embodiments of the present disclosure.

FIG. 2 illustrates a top view of the head-mountable device of FIG. 1 with another assembly arrangement, according to some embodiments of the present disclosure.

FIG. 3 illustrates a top view of a head-mountable device on a user, according to some embodiments of the present disclosure.

FIG. 4 illustrates the head-mountable device of FIG. 3 displaying an example user interface, according to some embodiments of the present disclosure.

FIG. 5 illustrates a flow chart for a process having operations performed by a head-mountable device, according to some embodiments of the present disclosure.

FIG. 6 illustrates a flow chart for a process having operations performed by a head-mountable device, according to some embodiments of the present disclosure.

FIG. 7 illustrates a flow chart for a process having operations performed by a head-mountable device, according to some embodiments of the present disclosure.

FIG. 8 illustrates a flow chart for a process having operations performed by a head-mountable device, according to some embodiments of the present disclosure.

FIG. 9 illustrates a block diagram of a head-mountable device and a band, in accordance with some embodiments of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Head-mountable devices, such as head-mounted displays, headsets, visors, smartglasses, head-up display, etc., can perform a range of functions that is determined by the components (e.g., sensors, circuitry, and other hardware) included with the wearable device as manufactured. However, space, cost, and other considerations may limit the ability to provide every component that might provide a desired function. For example, different users may have different preferences regarding the components and functions that are provided by a given head-mountable device. Some users may desire certain capabilities, such as high-resolution display and long battery life, while other users may desire other capabilities, such as smaller form factor. Furthermore, a given user may desire different functions at different times. For example, a given user may desire high-resolution display at home and long battery life when outside the home.

Given the diversity of desired components and functions, it would be beneficial to allow a user to modify components and functions of a head-mountable device to customize the user experience according to the user's desires. Head-mountable devices of the present disclosure facilitate customization, adaptability, and modification by a user according to the user's desires.

Systems of the present disclosure can provide a head-mountable device with attachable and exchangeable bands that provide a variety of different components and functions to achieve the results that are desired by a user. The attachable and exchangeable configurations allow a user to easily customize a head-mountable device with one or more bands to provide features that integrate with other operations of the head-mountable device. The bands can be easily exchanged with each other to provide different components and functions at different times. A selection of a certain band can influence operation of the head-mountable device in a variety of ways. For example, the head-mountable device can respond to the identification of a particular band by performing particular functions, such as changing an aspect of a user interface or altering settings of the head-mountable device. Such functions can be readily executed by the head-mountable device upon identification of the band, such that user input is not required. Accordingly, a user's experience with the head-mountable device can be enhanced based on the user's selection of a particular band.

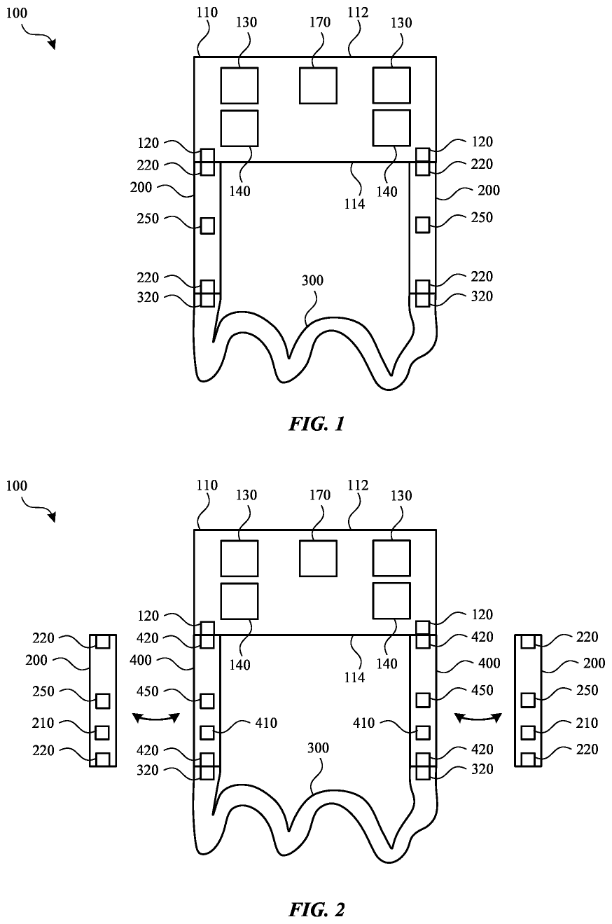

These and other embodiments are discussed below with reference to FIGS. 1-8. However, those skilled in the art will readily appreciate that the detailed description given herein with respect to these Figures is for explanatory purposes only and should not be construed as limiting.

According to some embodiments, for example as shown in FIG. 1, a head-mountable device 100 includes a frame 110. The frame 110 can be worn on a head of a user. The frame 110 can be positioned in front of the eyes of a user to provide information within a field of view of the user. The frame 110 can provide nose pads and/or other portions to rest on a user's nose, forehead, cheeks, and/or other facial features.

The frame 110 can provide structure around a peripheral region thereof to support any internal components of the frame 110 in their assembled position. For example, the frame 110 can enclose and support various internal components (including for example integrated circuit chips, processors, memory devices and other circuitry) to provide computing and functional operations for the head-mountable device 100, as discussed further herein. While several components are shown within the frame 110, it will be understood that some or all of these components can be located anywhere within or on the head-mountable device 100. For example, one or more of these components can be positioned within the head engager 300, the bands 200, and/or the frame 110 of the head-mountable device 100.

The head-mountable device 100 can include one or more user sensors 170 for tracking features of the user wearing the head-mountable device 100. Such a sensor can be located at, included with, and/or associated with the frame 110, the bands 200, and/or the head engager 300. For example, a sensor 170 can be a user sensor to perform facial feature detection, facial movement detection, facial recognition, eye tracking, user mood detection, user emotion detection, voice detection, etc. Such eye tracking may be used to determine a location of information to be displayed on the displays 140 and/or a portion (e.g., object) of a view to be analyzed by the head-mountable device 100. By further example, the user sensor can be a bio-sensor for tracking biometric characteristics, such as health and activity metrics. The user sensor can include a bio-sensor that is configured to measure biometrics such as electrocardiographic (ECG) characteristics, galvanic skin resistance, and other electrical properties of the user's body. Additionally or alternatively, a bio-sensor can be configured to measure body temperature, exposure to UV radiation, and other health-related information.

The frame 110 can include and/or support one or more cameras 130. The cameras 130 can be positioned on or near an outer side 112 of the frame 110 to capture images of views external to the head-mountable device 100. As used herein, an outer side of a portion of a head-mountable device is a side that faces away from the user and/or towards an external environment. The captured images can be used for display to the user or stored for any other purpose. Each of the cameras 130 can be movable along the outer side 112. For example, a track or other guide can be provided for facilitating movement of the camera 130 therein.

The head-mountable device 100 can include displays 140 that provide visual output for viewing by a user wearing the head-mountable device 100. One or more displays 140 can be positioned on or near an inner side 114 of the frame 110. As used herein, an inner side 114 of a portion of a head-mountable device is a side that faces toward the user and/or away from the external environment.

A display 140 can transmit light from a physical environment (e.g., as captured by a camera) for viewing by the user. Such a display 140 can include optical properties, such as lenses for vision correction based on incoming light from the physical environment. Additionally or alternatively, a display 140 can provide information as a display within a field of view of the user. Such information can be provided to the exclusion of a view of a physical environment or in addition to (e.g., overlaid with) a physical environment.

A physical environment refers to a physical world that people can interact with and/or sense without necessarily requiring the aid of an electronic device. A computer-generated reality environment relates to a partially or wholly simulated environment that people sense and/or interact with the assistance of an electronic device. Examples of computer-generated reality include, but are not limited to, mixed reality and virtual reality. Examples of mixed realities can include augmented reality and augmented virtuality. Examples of electronic devices that enable a person to sense and/or interact with various computer-generated reality environments include head-mountable devices, projection-based devices, heads-up displays (HUDs), vehicle windshields having integrated display capability, windows having integrated display capability, displays formed as lenses designed to be placed on a person's eyes (e.g., similar to contact lenses), headphones/earphones, speaker arrays, input devices (e.g., wearable or handheld controllers with or without haptic feedback), smartphones, tablets, and desktop/laptop computers. A head-mountable device can have an integrated opaque display, have a transparent or translucent display, or be configured to accept an external opaque display from another device (e.g., smartphone).

The frame 110 can optionally be supported on a user's head with bands 200 and/or a head engager 300. The bands 200 and/or the head engager 300 can wrap around or extend along opposing sides of a user's head. The bands 200 and/or the head engager 300 can optionally include earpieces for wrapping around or otherwise engaging or resting on a user's ears. It will be appreciated that other configurations can be applied for securing the head-mountable device 100 to a user's head. For example, one or more bands, straps, belts, caps, hats, or other components can be used in addition to or in place of the illustrated components of the head-mountable device 100. By further example, the bands 200 and/or the head engager 300 can include multiple components to engage a user's head. In some embodiments, the head engager 300 can be omitted and the bands 200 can secure the frame 110 to a head and/or face of the user.

Referring now to FIGS. 1 and 2, a head-mountable device can be provided with one or more bands for further enhancing functionality of the head-mountable device. For example, a band 200 can be attached and operably connected to the frame 110. While two bands are shown in FIGS. 1 and 2, it will be understood that the description herein can apply to each of any number of bands. The band 200 can be provided at any portion of the head-mountable device 100, such as between the frame 110 and the head engager 300, where provided. For example, the band 200 can be provided on an inner, outer, top, bottom, front, or rear side of the frame 110.

As shown in FIGS. 1 and 2, the band 200 can attach to the head-mountable device 100 with the frame connectors 120 and the band connectors 220. Attachment can be achieved with an engagement that holds the band 200 in place relative to the head-mountable device until controlled release, for example by a user.

The frame connectors 120 and the band connectors 220 can include mechanisms, such as magnets, that engage each other for securement of the band 200 to the frame 110. In some embodiments, the frame connectors 120 and the band connectors 220 can mechanically engage each other for securement of the band 200 to the frame 110. The frame connectors 120 and the band connectors 220 can have complementary shapes to facilitate engagement. For example, the frame connectors 120 and/or the band connectors 220 can form a protrusion and the band connectors 220 and/or the frame connectors 120 can form a groove. The groove can have a shape and/or size that complement the shape and/or size of the frame connectors 120. It will be understood that a variety of shapes and/or sizes can be provided to achieve the engagement between the frame connectors 120 and the band connectors 220. It will be further understood that any number of frame connectors 120 and band connectors 220 can be provided. While certain mechanical attachment mechanisms are depicted, it will be understood that other mechanical attachment mechanisms are also contemplated. Additionally or alternatively, the band connector 220 can be pressed, snap fit or otherwise inserted into the frame connector 120. Once inserted, the band connector 220 can be locked or otherwise secured within the frame connector 120. Additional or alternative mechanisms can be provided to lock the band 200 in place with respect to the frame 110. For example, mechanisms such as locks, latches, snaps, screws, clasps, threads, magnets, pins, an interference (e.g., friction) fit, knurl presses, bayoneting, and/or combinations thereof can be included to lock the band 200 to the frame 110 when the frame connectors 120 and the band connectors 220 engage each other.

As further shown in FIGS. 1 and 2, the bands 200 can each attach to the head engager 300 and/or each other with the band connectors 220 and the head engager connectors 320. The features described herein with respect to the interactions between the frame connectors 120 and the band connectors 220 can apply to the interactions between the band connectors 220 and the head engager connectors 320.

The band 200 can optionally remain locked from moving with respect to the head-frame 110 until a release mechanism is actuated. The release mechanism can be provided on an outer surface of the frame 110 for access by a user. For example, the release mechanism can be provided on an outer surface of the frame 110 and/or the band 200. Where a locking mechanism locks the band 200 in place with respect to the frame 110, the release mechanism, when actuated, can move and act upon the locking mechanism to cause it to release. For example, the release mechanism, when actuated, can release one or more locks, latches, snaps, screws, clasps, threads, magnets, pins, an interference (e.g., friction) fit, knurl presses, bayoneting, and/or combinations thereof that were previously locking the band 200 to the frame 110. At least some of the interactions between the release mechanism and a locking mechanism can be within the frame 110 and/or the band 200.

An electrical or other communication connection can be made and maintained upon mechanical securement of the frame connector 120 and the band connector 220, for example via communication interfaces integrated into and/or separate from the frame connectors 120 and the band connectors 220. Accordingly, when the frame 110 is connected to the band 200, components thereof can be in operative communication. For example, such communication interfaces can include a moveable element for making an electrical connection, such as a pogo pin that is at least partially collapsible and/or a contact pad that is at least partially flexible. By further example, a pogo pin can be spring loaded and/or a contact pad can be formed from an electrically conductive foam or elastomer. Additionally or alternatively, the communication interfaces can include connectors that are manually connected to establish a communication interface apart from the engagement with the frame connectors 120 and the band connectors 220. Such connectors can include ZIF connectors, non-ZIF connectors, slider connectors, flip actuator connectors, and/or FPC-to-Board connectors. It will be understood that a variety of other communication links can be provided between the frame 110 and the bands 200. No direct contact may be required to establish a communication link. For example, a communication link between the communication interfaces can include wireless interfaces, Bluetooth interfaces, Near Field Communication interfaces, magnetic interfaces, inductive interfaces, resonant interfaces, capacitive coupling interfaces, Wi-Fi interfaces, optical interfaces, acoustic interfaces, and/or other communication interfaces. The communication interfaces can facilitate communication (e.g., transfer) of power, data, or other signals between components of the band 200 and the frame 110.

The bands 200 can each include a band identifier 250. Features of the band identifier 250 can be selected to achieve detection by the frame 110, as described further herein. For example, the band identifier 250 can include a feature on a surface of the band 200 and/or be embedded within the structure of the band 200. The band identifier 250 can be positioned on or along any portion of the band 200 to facilitate detection. The band identifier 250 can be a memory that is accessible by the head-mountable device (e.g., a processor) when connected by the connectors 120 and 220. The band identifier 250 can be detected to determine information about the band 200, such as a type, characteristic, feature, or identity of the band 200. Subsequent actions by the frame 110 can correspond to the determined information.

In some embodiments, the frame 110 can include one or more contact pins (e.g., at or near the frame connector 120) for providing an electrically conductive pathway to the band identifier 250 of the band 200 (e.g., via the band connector 220). Multiple pins can be provided to conduct power, provide a connection to ground, and/or transmit signals.

In some embodiments, the band identifier 250 is an optically detectable feature, such as a barcode, including a machine-readable representation of information in the form of one or more patterns. The symbol may be formed as patterns of dark (e.g., black) and light (e.g., white) bars, circles, dots or other shapes. Other patterns are contemplated, such as patterns of dots, concentric circles and the like. Other examples of barcodes include Universal Product Codes (UPCs), Code 39 barcodes, Code 128 barcodes, PDF417 barcodes, EZcode barcodes, DataMatrix barcodes, QR Codebarcodes, or barcodes that utilize any other type of barcode symbology. A 1D sensor or a 2D sensor can be used to capture images of adequate resolution (e.g., pixels) to detect the band identifier 250 (e.g., barcode). With some sensors, such as a camera 130 of the frame 110, the barcode can be scanned by swiping the barcode in front of the camera 130.

In some embodiments, the frame 110 can detect a band identifier 250 of a band 200 by using a sensor that applies a communication protocol. Wireless or wired communication can be performed, at least in part, by a sensor such as a communication interface of the frame 110. Communication between the band identifier 250 and the frame 110 can employ a short-range communication method, such as near field communication (“NFC”), radio-frequency identification (“RFID”), Bluetooth, Wi-Fi, Wi-Fi Direct, short-range 802.11, and high frequency focused beams such as 60 GHZ. Alternatively or additionally, communication between the band 200 and the frame 110 can employ a high frequency communication method, such as WirelessHD, WiGig, and Wi-Fi IEEE 802.11ad.

In some embodiments, the frame 110 can detect a band identifier 250 of a band 200 by using a sensor such as a magnetic field sensor and the band identifier 250 can include one or more magnets. Where multiple magnets are included, the band identifier 250 can include an arrangement of the magnets (e.g., different north-south orientations) that is distinct from the arrangement of another band identifier 250 of a different band 200. The magnets can be arranged near the band connector 220, such that coupling to the frame connector 120 brings the band identifier 250 into range of the sensor.

Referring now to FIGS. 1 and 2, a head-mountable device can be provided with one or more bands for further enhancing functionality of the head-mountable device. For example, a band 200 can be attached and operably connected to the frame 110. While two bands are shown in FIGS. 1 and 2, it will be understood that the description herein can apply to each of any number of bands. The band 200 can be provided at any portion of the head-mountable device 100, such as between the frame 110 and the head engager 300, where provided. For example, the band 200 can be provided on an inner, outer, top, bottom, front, or rear side of the frame 110.

As shown in FIGS. 1 and 2, the band 200 can attach to the head-mountable device 100 with the frame connectors 120 and the band connectors 220. Attachment can be achieved with an engagement that holds the band 200 in place relative to the head-mountable device until controlled release, for example by a user.

The frame connectors 120 and the band connectors 220 can include mechanisms, such as magnets, that engage each other for securement of the band 200 to the frame 110. In some embodiments, the frame connectors 120 and the band connectors 220 can mechanically engage each other for securement of the band 200 to the frame 110. The frame connectors 120 and the band connectors 220 can have complementary shapes to facilitate engagement. For example, the frame connectors 120 and/or the band connectors 220 can form a protrusion and the band connectors 220 and/or the frame connectors 120 can form a groove. The groove can have a shape and/or size that complement the shape and/or size of the frame connectors 120. It will be understood that a variety of shapes and/or sizes can be provided to achieve the engagement between the frame connectors 120 and the band connectors 220. It will be further understood that any number of frame connectors 120 and band connectors 220 can be provided. While certain mechanical attachment mechanisms are depicted, it will be understood that other mechanical attachment mechanisms are also contemplated. Additionally or alternatively, the band connector 220 can be pressed, snap fit or otherwise inserted into the frame connector 120. Once inserted, the band connector 220 can be locked or otherwise secured within the frame connector 120. Additional or alternative mechanisms can be provided to lock the band 200 in place with respect to the frame 110. For example, mechanisms such as locks, latches, snaps, screws, clasps, threads, magnets, pins, an interference (e.g., friction) fit, knurl presses, bayoneting, and/or combinations thereof can be included to lock the band 200 to the frame 110 when the frame connectors 120 and the band connectors 220 engage each other.

One of a variety of bands can be used at different times with a given frame of a head-mountable device. FIG. 2 illustrates a top view of a system including a frame and multiple bands, in accordance with some embodiments of the present disclosure.

As shown in FIG. 2, a system can include a frame 110 and one or more bands 200 and 400. It should be appreciated however that any number of frames and bands may be provided. Each of bands 200 and 400 may be configured differently. For example, the functional aspects and the aesthetic aspects may be configured differently. The first band 200 may have a first band identifier 250, and the second band 400 may have a second band identifier 450. Additional bands can also have the same or different components. Additionally or alternatively, one or more of the bands can include electronic circuits, such as the electronic circuits 210 and 410, that can provide different functions, as discussed further herein, so that attachment of a given band provides different functions to the same frame 110 of the head-mountable device 100. Each band can include one or more electronic circuits such as sensors, bio-sensors, batteries, I/O components, communication interfaces, controllers, and the like, as discussed further herein.

It will be recognized that the difference in functionality can refer to both the purpose of a component as well as the parameters of its operation. For example, while the components of different bands can both be for a common purpose, the components can operate differently to achieve the purpose. For example, different components can be for sensing a biometric characteristic, such as heart rate. However, the different components can be calibrated differently based on the user. Other variations, such as size, shape, and material selection can be provided so the user can select the band that is best suited for the user's comfort and/or performance of the component.

The different bands can also differ in mechanical configuration such as material properties and/or structural features, which can help define shape, size, flexibility, rigidity, tactile feel, ergonomic features, and/or aesthetic properties such as color, patterns, and/or materials to provide a different look and feel. Furthermore, each of the bands may have a different enclosure having a different color, material, shape, accoutrements, patterns, etc. The enclosures can provide different aesthetic features, cosmetic features, and/or a look and feel than the other enclosures in the system.

While the components of the bands 200 and 400 can differ, the bands 200 and 400 can have the same or similar connectors 220 and 420, so that each of the bands 200 and 400 can attach to the frame 110 via the frame connectors 120 in the same or similar manner. Furthermore, the bands 200 and 400 can have the same or similar communication interfaces, so that each of the components thereof can communicate with the frame 110 in the same or similar manner.

Accordingly, each band is configured to provide a different function and/or aesthetic feature than one or more other bands in the system. As such, the user can select the band with the desired functionality and/or look and feel. This may be at the time of purchase, thus allowing differentiation from other purchasers, or it may be that all or some portion of the bands come in a set such that the user can select the desired bands for the right moment. In one example, one band may be configured for exercise (e.g., with sensors and/or bio-sensors), while another may be configured for a regular use (e.g., with an auxiliary battery and/or cosmetic features). Any combination of aesthetic and functional features may be provided to create a different head-mountable device. When combined with the different frames, the system becomes highly customizable. The user can create a different head-mountable device by selecting one frame to go along with one band. If multiple systems are provided, any number of different head-mountable device configurations can be made.

A user having access to multiple bands and/or multiple frames can have a variety of options by combining different pairings of bands and frames. Additionally or alternatively, a provider of head-mountable devices can provide a variety of bands and/or frames that can be selected by a user at a point of sale. A user can select one or more bands and one or more frames when placing an order. The provider can combine the one or more bands and one or more frames to assemble a custom head-mountable device according to the user's order. The head-mountable device can then be provided to the user with the one or more bands and one or more frames as desired.

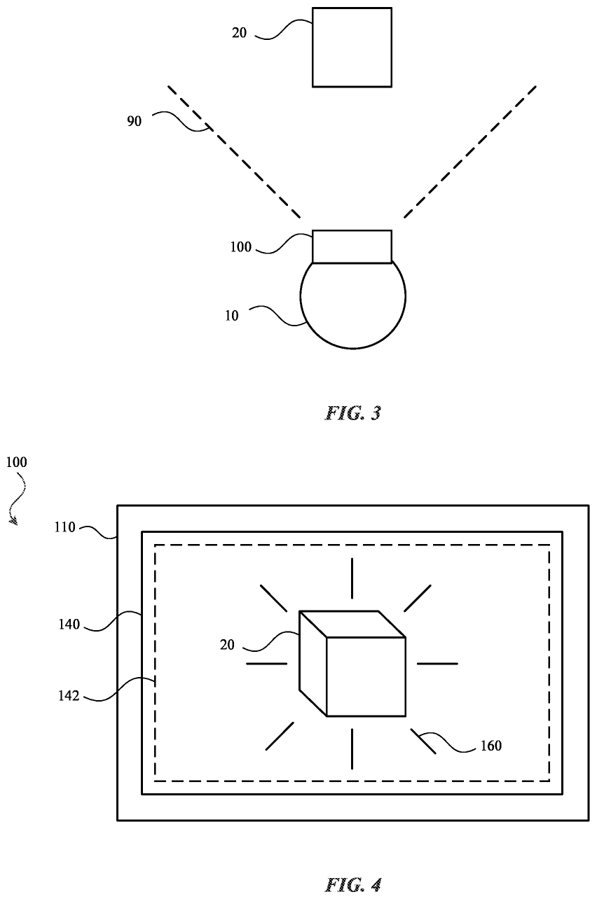

Referring now to FIGS. 3 and 4, a user can wear and/or operate a head-mountable device that provides outputs based on a captured view that can be enhanced based on an identified band. As shown in FIG. 3, a user 10 can wear the head-mountable device 100, which provides a field of view 90 of a physical environment. A physical object 20 can be located within the environment, for example within the field of view 90. While only one physical object 20 is illustrated in FIG. 3, it will be understood that any number of physical objects 20 can be captured within the field of view 90.

The head-mountable device 100 can perform object recognition with respect to the physical object 20. For example, a sensor other than the primary camera of the head-mountable device can detect, measure, and/or analyze the object 20 to determine a characteristic thereof. Object recognition can be facilitated by a proximity sensor, a depth sensor, and/or another camera of the head-mountable device 100. Additionally or alternatively, object recognition can be facilitated by one or more other devices. For example, the head-mountable device 100 can be in communication with another device that performs object recognition and communicates results to the head-mountable device 100. It will be understood that a wide variety of physical objects 20 can be recognized, including items, devices, people, buildings, geographic features, locations, and the like. A characteristic of the physical object 20 can include an identity, name, type, reference, color, size, shape, distance, position, velocity, acceleration, make, model, or other feature detectable by the head-mountable device 100.

As shown in FIG. 4, a head-mountable device can provide a user interface to prompt and/or guide a user to adjust the head-mountable device to achieve a target alignment. FIG. 4 illustrates a rear view of a head-mountable device operable by a user, the head-mountable device providing a user interface, according to some embodiments of the present disclosure. The display 140 can provide a user interface 142. Not all of the depicted graphical features may be used in all implementations, however, and one or more implementations may include additional or different graphical features than those shown in the figure. Variations in the arrangement and type of the graphical features may be made without departing from the spirit or scope of the claims as set forth herein. Additional components, different components, or fewer components may be provided.

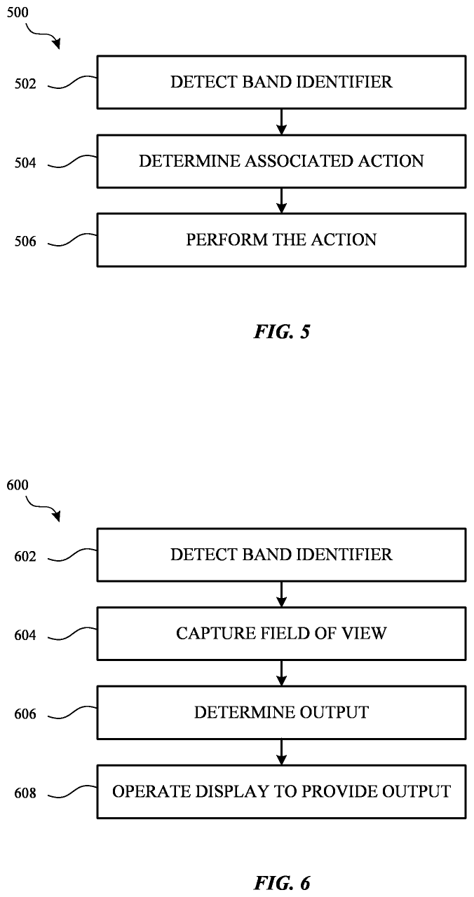

As shown in FIG. 4, the user interface 142 can include one or more visual features. For example, the user interface 142 can include an image corresponding to the field of view 90 as well as a visual feature 160 that that is provided with respect to the object 20, as shown in FIG. 5. Additionally or alternatively, the visual feature 160 can be applied to the physical object 20. While various types of visual output are discussed below with respect to objects 20, it will be understood that the head-mountable device 100 can provide such visual outputs with respect to any physical object 20 that is detected by the head-mountable device 100. As such, it will be understood that the description herein relating to visual outputs can apply to objects, scenes, view, and the like. It will be understood that the view can correspond to a physical environment and/or a CGR environment. The visual feature 160 can include highlighting, glow, shadow, reflection, outline, border, text, icons, symbols, emphasis, duplication, aura, and/or animation provided with the view of the object 20. Such a visual feature 160 can be provided optionally without altering the appearance of the object 20. For example, the visual feature 160 can be provided about an outer periphery of the object 20. Additionally or alternatively, the visual feature 160 can be provided with partial or entire overlap (e.g., overlaid) with respect to the object 20.

The visual feature 160 and/or other outputs included in the user interface 142 can be based on the selected band in use with the head-mountable device. For example, the head-mountable device can detect a band and alter the visual output based on programmed parameters associated with the band identifier of the band, as described further herein.

FIG. 5 illustrates a flow diagram for detecting a band and operating a head-mountable device. For explanatory purposes, the process 500 is primarily described herein with reference to the head-mountable device 100 and/or the bands 200 and 500 of FIGS. 1-4. However, the process 500 is not limited to the head-mountable device 100 of FIGS. 1-4, and one or more blocks (or operations) of the process 500 may be performed by different components of the head-mountable device and/or one or more other devices. Further for explanatory purposes, the blocks of the process 500 are described herein as occurring in serial, or linearly. However, multiple blocks of the process 500 may occur in parallel. In addition, the blocks of the process 500 need not be performed in the order shown and/or one or more blocks of the process 500 need not be performed and/or can be replaced by other operations.

In an operation 502, the head-mountable device (e.g., at the frame) can initiate a scan for a band identifier. The head-mountable device can be placed into a scanning mode based on manual and/or automated initiation. For example, the user can place the head-mountable device into a scanning mode by providing manual inputs to the head-mountable device. For at least a limited period of time thereafter, the head-mountable device can activate its components to scan for the band identifier of a band. Alternatively or additionally, the head-mountable device can automatically activate its components after it senses the presence of a band identifier. Additionally or alternatively, the head-mountable device can initiate a scan for a band identifier upon detection that the head-mountable device is worn by a user. For example, when the head-mountable device detects that it is being worn (e.g., based on proximity to a user as can be sensed by the PPG sensor) after a period of not being worn, the head-mountable device can initiate a scan to detect the band identifier of any band present. By further example, the head-mountable device can detect the presence of a band based on sensed changes, such as a change in impedance or inductance of a coil when the band is inserted into the head-mountable device. Such changes can be used to initiate a scan. Additionally or alternatively, the head-mountable device can initiate scans periodically or based on a predetermined schedule.

The head-mountable device can detect a band identifier of a band. Exemplary components and mechanisms for detecting the band identifier are described above. One of more of these components and/or mechanisms can be applied to effectively detect the band identifier. Once the band identifier has been detected, a record thereof can be stored within a memory of the head-mountable device. The band identifier can be an indicator of a feature of the band. For example, the band identifier can indicate a type, model, color, size, or other characteristic of the band. Where the band identifier indicates one characteristic (e.g., model) of the band, other characteristics (e.g., color, size) can be inferred.

The identification can serve as an input to determine an action to be performed by the head-mountable device. In an operation 504, the head-mountable device can determine an action associated with the band identifier. Each of a variety of band identifiers corresponding to different bands can be recorded in the memory of the head-mountable device. Each of the recorded band identifiers can have associated therewith a corresponding action. The record of band identifiers and associated actions can be in the form of a table, array, or other data structure. When a given band identifier is detected, it can be compared with the recorded band identifiers to find a match and determine the corresponding action. While the foregoing discussion relates to referencing memory onboard the head-mountable device, it will be recognized that the head-mountable device can reference another database apart from the head-mountable device. The association of band identifiers and corresponding actions can be preprogrammed, user-selected, or a result of machine-learning based on prior usage with one or more bands.

In an operation 506, the head-mountable device can perform the action that has been determined to be associated with the band identifier. For example, the recorded action corresponding to the detected band identifier can include instructions for execution by the processor and/or other components of the head-mountable device. Alternatively or additionally, the action can include causing another device, apart from the head-mountable device, to execute instructions. The action can be performed automatically upon identification of a band. Additionally or alternatively, the head-mountable device can provide a prompt requesting user confirmation of the action, and the action can be performed after user confirmation is received. Additionally or alternatively, a user can manually override or modify the action.

Various exemplary actions are discussed below. Actions performed by the head-mountable device in response to detection of a band identifier include influencing regular operation of the head-mountable device. For example, the regular operation of the head-mountable device can be maintained with additional or altered features based on the selected band. As such, the user's experience with the head-mountable device during its regular operation is enhanced.

Actions performed by the head-mountable device in response to detection of a band identifier include actions outside of the regular operation of the head-mountable device. For example, the head-mountable device can perform actions that are only available when a particular band is detected. As such, the user's experience with the head-mountable device is expanded with the selection of bands.

FIG. 6 illustrates another flow diagram for detecting a band and operating a head-mountable device. For explanatory purposes, the process 600 is primarily described herein with reference to the head-mountable device 100 and/or the bands 200 and 600 of FIGS. 1-4. However, the process 600 is not limited to the head-mountable device 100 of FIGS. 1-4, and one or more blocks (or operations) of the process 600 may be performed by different components of the head-mountable device and/or one or more other devices. Further for explanatory purposes, the blocks of the process 600 are described herein as occurring in serial, or linearly. However, multiple blocks of the process 600 may occur in parallel. In addition, the blocks of the process 600 need not be performed in the order shown and/or one or more blocks of the process 600 need not be performed and/or can be replaced by other operations.

In an operation 602, the head-mountable device (e.g., at the frame) can initiate a scan for a band identifier and detect a band identifier of a band, as described herein.

In an operation 604, the head-mountable device can capture a view, for example with a camera thereof. Additionally or alternatively, the view can be computer-generated. In such an example, the CGR can optionally be based on a view of a physical environment.

In an operation 606, the head-mountable device can determine an output. The output can be based on the view (e.g., captured by the camera) as well as the band identifier of the band. For example, the output can be a visual output provided by a user interface, such as that illustrated in FIG. 4. Additionally or alternatively, the output can include audio, haptic feedback, and the like.

In an operation 608, the head-mountable device can provide the output, for example with a display thereof. In some embodiments, upon identifying a particular band, the head-mountable device provides a feature of a visual user interface that corresponds to a characteristic of the band. For example, displayed information, menu items, and selectable elements can be selected based on the selection of band. Where the band is identified as having output parameters associated therewith, the user interface provided by the display can provide such output, applying settings and features based on the identification of the band. As such, the band can allow a user to have an experience that would not be available with a different band and/or with no band.

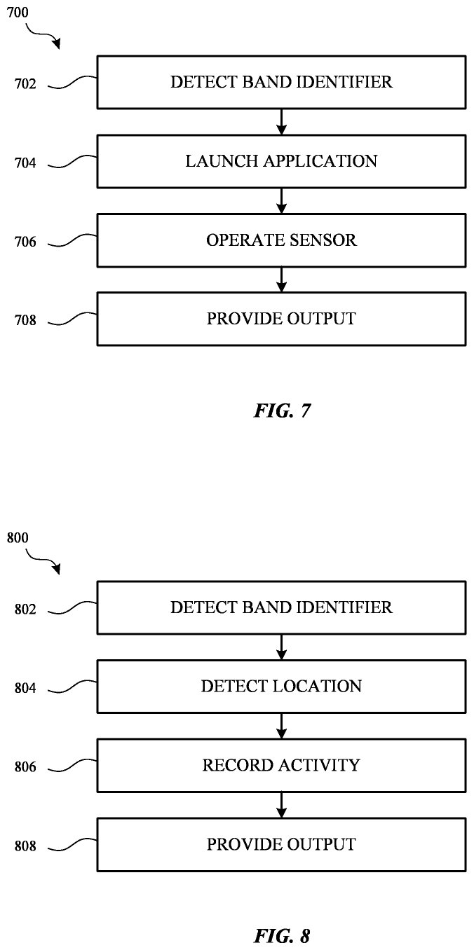

FIG. 7 illustrates another flow diagram for detecting a band and operating a head-mountable device. For explanatory purposes, the process 700 is primarily described herein with reference to the head-mountable device 100 and/or the bands 200 and 700 of FIGS. 1-4. However, the process 700 is not limited to the head-mountable device 100 of FIGS. 1-4, and one or more blocks (or operations) of the process 700 may be performed by different components of the head-mountable device and/or one or more other devices. Further for explanatory purposes, the blocks of the process 700 are described herein as occurring in serial, or linearly. However, multiple blocks of the process 700 may occur in parallel. In addition, the blocks of the process 700 need not be performed in the order shown and/or one or more blocks of the process 700 need not be performed and/or can be replaced by other operations.

In an operation 702, the head-mountable device (e.g., at the frame) can initiate a scan for a band identifier and detect a band identifier of a band, as described herein.

In an operation 704, the head-mountable device can launch an application in response to the detection of the band identifier of the band. For example, a band can be associated with an activity that is supported by the head-mountable device. For example, an exercise band can be worn when a user is exercising. Upon identification of the exercise band, actions conducive to an exercise session can be performed by the head-mountable device. For example, the head-mountable device can display particular information, track activity of the user, take a biometric reading, record a location of the user, launch an activity tracking app, and/or modify notifications settings (e.g., to be more prominent).

In an operation 706, the head-mountable device can operate a sensor, for example during an exercise session. The sensor can be a sensor of the head-mountable device (e.g., in the frame) and/or of the band. For example, the band can provide sensors and/or other electronic circuits that are conducive to the application that is launched upon detection of the band.

In some embodiments, upon identifying a particular band, other settings of the head-mountable device can be modified. By further example, another type of band can be worn in a different setting (e.g., when not exercising). Upon identification of such a band, actions conducive to the different setting can be performed by the head-mountable device. For example, the head-mountable device can display particular information, modify notifications settings (e.g., to be less prominent), provide reminders to the user, and/or record a location of the user.

The head-mountable device can perform a variety of other actions upon identification of a band. It will be recognized that the detection of a band identifier can be followed by any associated action that can be performed by the head-mountable device. For example, where the head-mountable device has the required capabilities, the head-mountable device launches an app, opens a website, starts a timer, displays a message, provides an alert, communicates with another device, and/or other functions.

In an operation 708, the head-mountable device can provide an output, for example with a display thereof. In some embodiments, upon identifying a particular band, the head-mountable device provides a feature of a visual user interface that corresponds to a characteristic of the band. For example, displayed information, menu items, and selectable elements can be selected based on the selection of band and/or the operation(s) of the application.

FIG. 8 illustrates another flow diagram for detecting a band and operating a head-mountable device. For explanatory purposes, the process 800 is primarily described herein with reference to the head-mountable device 100 and/or the bands 200 and 800 of FIGS. 1-4. However, the process 800 is not limited to the head-mountable device 100 of FIGS. 1-4, and one or more blocks (or operations) of the process 800 may be performed by different components of the head-mountable device and/or one or more other devices. Further for explanatory purposes, the blocks of the process 800 are described herein as occurring in serial, or linearly. However, multiple blocks of the process 800 may occur in parallel. In addition, the blocks of the process 800 need not be performed in the order shown and/or one or more blocks of the process 800 need not be performed and/or can be replaced by other operations.

In an operation 802, the head-mountable device (e.g., at the frame) can initiate a scan for a band identifier and detect a band identifier of a band, as described herein.

In an operation 804, the head-mountable device can detect a location thereof in response to the detection of the band identifier of the band. The location can be detected, for example, with one or more sensors, such as satellite and/or global positioning sensor (GPS) components, tracking components, beacon components, and the like.

A band can be associated with an activity that is specific to a location, venue, building, park, and the like. By further example, the band can be distributed by a venue operator for use in the venue. Based on the identification of the band and the detection that the head-mountable device is in the corresponding location, the head-mountable device can provide outputs to facilitate a user experience at the venue. In some embodiments, the bands can be provided as promotional items in conjunction with an event. For example, bands can be provided at a festival, convention, conference, concert, or reunion, to provide attendees possessing the bands with access items of value that are associated with the event. Each attendee can access the items of value by using the bands with their respective head-mountable device.

In an operation 806, the head-mountable device can record an activity. For example, while the band is detected and/or while at a detected location determined to be associated with the band, the head-mountable device can record an activity of the user and/or the head-mountable device. The recorded information can include images, videos, audio, user inputs, health metrics, activity metrics, and the like.

In an operation 808, the head-mountable device can provide an output, for example with a display thereof. In some embodiments, upon identifying a particular band, the head-mountable device provides a feature of a visual user interface that corresponds to a characteristic of the band. For example, displayed information, menu items, and selectable elements can be selected based on the selection of band and/or the detected location.

In some embodiments, a band can include a band identifier that provides authorization for otherwise unavailable actions. For example, a band can facilitate redemption of items of value. The band can be used with the head-mountable device to redeem items of value, such as credit, gift cards, funds, cash, prizes, digital media, access to content (e.g., online content), goods, and/or services. The band identifier can provide information to the head-mountable device for authorizing redemption of an item of value. For example, the band identifier can include a code that is verifiable by an external device. The head-mountable device can identify a band and communicate with the external device, which manages the redemption. Information from the band identifier can be transmitted from the head-mountable device to the external device. The external device can verify the information and authorize redemption of an item of value. The external device can further manage the redemption by executing a transfer to an account associated with the head-mountable device. Bands that facilitate redemption of items of value can be provided by vendors, retailers, service providers, or entities that manage the redemption process. The bands can be provided, exchanged, and transferred for sale or as gifts based on the value of the redeemable items.

In some embodiments, a band and a head-mountable device can interact and operate in a manner that is not necessarily perceivable by a user. For example, a head-mountable device can track usage of one or more bands. The tracked usage information includes dates, times, durations, locations, activities, biometrics of the user, and/or environmental features in relation to periods before, during, and/or after usage of each band. The tracked usage information can be collected during a background process of the head-mountable device. The tracked usage information can be output to a user or uploaded to an external device for analysis. The tracked usage information can be used for machine learning in relation to how each band is used.

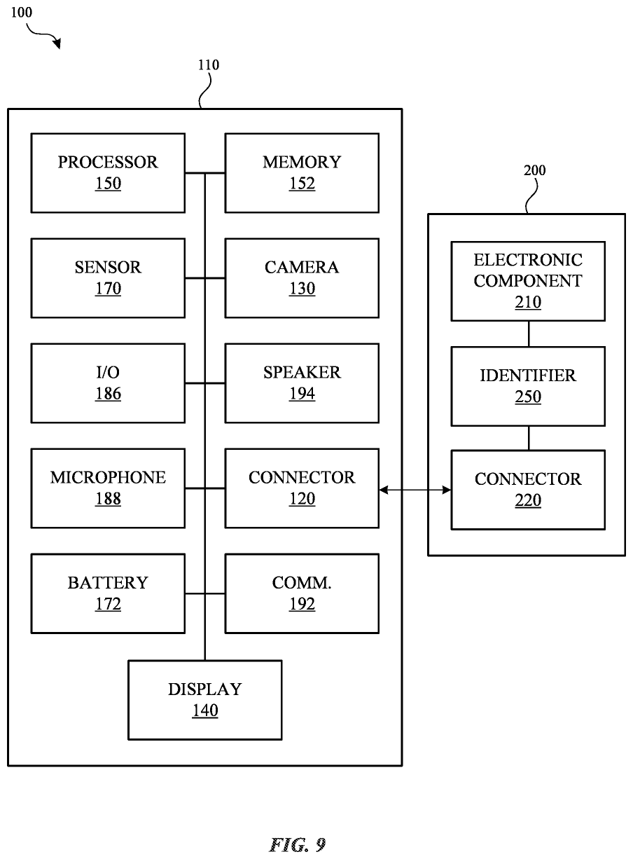

Referring now to FIG. 9, components of the head-mountable device can be operably connected to provide the performance described herein. FIG. 9 shows a simplified block diagram of an illustrative head-mountable device 100 and a band 200 in accordance with one embodiment of the invention. It will be appreciated that components described herein can be provided on one, some, or all of a frame, a band, and/or a head engager. It will be understood that additional components (e.g., multiple bands 200), different components, or fewer components than those illustrated may be utilized within the scope of the subject disclosure.

As shown in FIG. 9, the head-mountable device 100 can include, within or coupled to the frame 110, a processor 150 (e.g., control circuitry) with one or more processing units that include or are configured to access a memory 152 having instructions stored thereon. The instructions or computer programs may be configured to perform one or more of the operations or functions described with respect to the head-mountable device 100. The processor 150 can be implemented as any electronic device capable of processing, receiving, or transmitting data or instructions. For example, the processor 150 may include one or more of: a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements.

The memory 152 can store electronic data that can be used by the head-mountable device 100. For example, the memory 152 can store electrical data or content such as, for example, audio and video files, documents and applications, device settings and user preferences, timing and control signals or data for the various modules, data structures or databases, and so on. The memory 152 can be configured as any type of memory. By way of example only, the memory 152 can be implemented as random access memory, read-only memory, Flash memory, removable memory, or other types of storage elements, or combinations of such devices.

The head-mountable device 100 can further include a display 140 for displaying visual information for a user. The display 140 can provide visual (e.g., image or video) output. The display 140 can be or include an opaque, transparent, and/or translucent display. The display 140 may have a transparent or translucent medium through which light representative of images is directed to a user's eyes. The display 140 may utilize digital light projection, OLEDs, LEDS, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. The head-mountable device 100 can include an optical subassembly configured to help optically adjust and correctly project the image-based content being displayed by the display 140 for close up viewing. The optical subassembly can include one or more lenses, mirrors, or other optical devices.

The head-mountable device 100 can further include a camera 130 for capturing a view of an external environment, as described herein. The view captured by the camera can be presented by the display 140 or otherwise analyzed to provide a basis for an output on the display 140.

The head-mountable device 100 can include an input/output component 186, which can include any suitable component for connecting head-mountable device 100 to other devices. Suitable components can include, for example, audio/video jacks, data connectors, or any additional or alternative input/output components. The input/output component 186 can include buttons, keys, or another feature that can act as a keyboard for operation by the user.

The head-mountable device 100 can include the microphone 188 as described herein. The microphone 188 can be operably connected to the processor 150 for detection of sound levels and communication of detections for further processing, as described further herein.

The head-mountable device 100 can include the speakers 190 as described herein. The speakers 190 can be operably connected to the processor 150 for control of speaker output, including sound levels, as described further herein.

The head-mountable device 100 can include communications circuitry 192 for communicating with one or more servers or other devices using any suitable communications protocol. For example, communications circuitry 192 can support Wi-Fi (e.g., a 802.11 protocol), Ethernet, Bluetooth, high frequency systems (e.g., 900 MHZ, 2.4 GHz, and 5.6 GHz communication systems), infrared, TCP/IP (e.g., any of the protocols used in each of the TCP/IP layers), HTTP, BitTorrent, FTP, RTP, RTSP, SSH, any other communications protocol, or any combination thereof. Communications circuitry 192 can also include an antenna for transmitting and receiving electromagnetic signals.

The head-mountable device 100 can include one or more other sensors. Such sensors can be configured to sense substantially any type of characteristic such as, but not limited to, images, pressure, light, touch, force, temperature, position, motion, and so on. For example, the sensor can be a photodetector, a temperature sensor, a light or optical sensor, an atmospheric pressure sensor, a humidity sensor, a magnet, a gyroscope, an accelerometer, a chemical sensor, an ozone sensor, a particulate count sensor, and so on. By further example, the sensor can be a bio-sensor for tracking biometric characteristics, such as health and activity metrics. Other user sensors can perform facial feature detection, facial movement detection, facial recognition, eye tracking, user mood detection, user emotion detection, voice detection, etc. Sensors can include the camera 130 which can capture image-based content of the outside world.

The head-mountable device 100 can include a battery 172, which can charge and/or power components of the head-mountable device 100. The battery can also charge and/or power components connected to the head-mountable device 100, such as the bands 200.

Each band 200 can be controlled at least in part by the processor 150 of the head-mountable device 100. For example, while the band 200 is connected to the head-mountable device 100, the processor 150 of the head-mountable device 100 can operably connect to and/or control one or more components of the band 200 via the communication link provided by the connectors 120 and 220 and/or another communication interface.

Additionally or alternatively, the head-mountable device 100 can be controlled at least in part by the electronic circuit 210 of the band 200. For example, while the band 200 is connected to the head-mountable device 100, the electronic circuit 210 of a band 200 can operably connect to and/or control one or more components of the head-mountable device 100 via the communication link provided by the connectors 120 and 220 and/or another communication interface.

In some embodiments, the band 200 can operate as a power source for the head-mountable device 100. By providing power with a removable band, the user can select such a band according to anticipated power needs. The electronic circuit 210 can include a battery that is used to store and provide power to the head-mountable device 100 and/or the band 200. Optionally, the band 200 can recharge the battery 172 of the head-mountable device 100, for example, by directing power from the electronic circuit 210 (e.g., battery) across the connectors 120 and 220. Other pathways are contemplated, such as another link or wireless charging.

Further examples of electronic circuits 210 include sensors. By providing sensing capabilities with a removable module, the user can select such a band 200 when sensing particular conditions is desired. Such sensors can be configured to sense substantially any type of characteristic such as, but not limited to, images, pressure, light, touch, force, temperature, position, motion, and so on. For example, the sensor may be a photodetector, a temperature sensor, a light or optical sensor, an atmospheric pressure sensor, a humidity sensor, a magnet, a gyroscope, an accelerometer, a chemical sensor, an ozone sensor, a particulate count sensor, and so on. The sensor can be used to sense ambient conditions in a neighboring environment. The sensor can be provided with exposure to the environment, for example with an opening in the band 200.

Further examples of electronic circuits 210 include bio-sensors. By providing bio-sensing capabilities with a removable module, the user can select such a band 200 when tracking biometric characteristics, such as health and activity metrics, is desired. The one or more bio-sensors can include optical and/or electronic biometric sensors that may be used to compute one or more biometric characteristics. For example, a bio-sensor can include a light source and a photodetector to form a photoplethysmography (PPG) sensor. An optical (e.g., PPG) sensor or sensors may be used to compute various biometric characteristic including, without limitation, a heart rate, a respiration rate, blood oxygenation level, a blood volume estimate, blood pressure, or a combination thereof. One or more of the bio-sensors may also be configured to perform an electrical measurement using one or more electrodes. The electrical sensor(s) may be used to measure electrocardiographic (ECG) characteristics, galvanic skin resistance, and other electrical properties of the user's body. Additionally or alternatively, a bio-sensor can be configured to measure body temperature, exposure to UV radiation, and other health-related information.

Further examples of electronic circuits 210 include user sensors. Such sensors can be used to detect features relating to the user wearing the head-mountable device and/or other individuals. For example, user sensors can perform facial feature detection, facial movement detection, facial recognition, eye tracking, user mood detection, user emotion detection, voice detection, etc.

Further examples of electronic circuits 210 include speakers. Such speakers can be operated in concert with or independently of the speakers of the head-mountable device 100. Speakers of the band 200 can be provided and operated at locations that enhance the audio output of the combined system. For example, the speakers of the band 200 can be operated to provide spatial audio to the user.

Further examples of electronic circuits 210 include cameras. Such cameras can be operated in concert with or independently of the cameras 130 of the head-mountable device 100. Cameras of the band 200 can be provided and operated at locations that enhance the visual capture capabilities of the combined system.

Further examples of electronic circuits 210 include microphones. Such microphones can be operated in concert with or independently of microphones of the head-mountable device 100. For example, the microphones of the band 200 can be operated to capture directional audio from an environment of the user.

Further examples of electronic circuits 210 include components for receiving input from a user, providing output to a user, and/or performing other functions. Examples of such components include a speaker, a microphone, a display, a touch sensor, a haptic device, a camera, an optical sensor, a magnet, a gyroscope, an accelerometer, and/or another I/O component.

Examples of electronic circuits 210 include display drivers. By providing display drivers with a removable module, the user can select such a band 200 when certain display features are desired. Such display drivers can be configured to control the display 140 of the head-mountable device 100 (e.g., at the frame 110).

Each band 200 can further include any number of electronic circuits 210. By providing electronic components on a removable band, the user can optionally provide an appropriate band when selected functions are desired. At other times, other bands or no band can be selected, thereby reducing the need to have all features available at all times in the head-mountable device 100.

Accordingly, embodiments of the present disclosure provide a head-mountable device with attachable and exchangeable bands that provide a variety of different components and functions to achieve the results that are desired by a user. The attachable and exchangeable configurations allow a user to easily customize a head-mountable device with one or more bands to provide features that integrate with other operations of the head-mountable device. The bands can be easily exchanged with each other to provide different components and functions at different times. A selection of a certain band can influence operation of the head-mountable device in a variety of ways. For example, the head-mountable device can respond to the identification of a particular band by performing particular functions, such as changing an aspect of a user interface or altering settings of the head-mountable device. Such functions can be readily executed by the head-mountable device upon identification of the band, such that user input is not required. Accordingly, a user's experience with the head-mountable device can be enhanced based on the user's selection of a particular band.

Various examples of aspects of the disclosure are described below as clauses for convenience. These are provided as examples, and do not limit the subject technology.
Clause A: a head-mountable device comprising: a frame; a camera; a display for providing a view captured by the camera; a band releasably attached to the frame and configured to secure the frame to a head of a user, the band storing a band identifier; and a processor configured to: detect the band identifier; and operate the display to output a visual feature based on at least one of the band identifier or the view captured by the camera.
Clause B: a head-mountable device comprising: a frame; a display; a band releasably attached to the frame and configured to secure the frame to a head of a user, the band comprising a sensor and storing a band identifier; and a processor configured to: detect the band identifier; and based on the band identifier, launch an application configured to operate the sensor to detect a condition of the user and output a visual feature on the display.
Clause C: a head-mountable device comprising: a frame; a band releasably attached to the frame and configured to secure the frame to a head of a user, the band storing a band identifier; and a processor configured to: detect the band identifier; detect a location of the head-mountable device; and based on the band identifier and the location, record an activity while the head-mountable device is within a region associated with the band identifier.

One or more of the above clauses can include one or more of the features described below. It is noted that any of the following clauses may be combined in any combination with each other, and placed into a respective independent clause, e.g., clause A, B, or C.
Clause 1: the frame comprises a frame connector; and the band comprises a band connector to releasably engage the frame connector, wherein the band identifier is operably connected to the processor when the frame connector engages the band connector.
Clause 2: the band further comprises an electronic circuit, wherein the electronic circuit is operably connected to the processor when the frame connector engages the band connector.
Clause 3: electronic circuit is a sensor operable to detect a condition of the user.
Clause 4: the processor is further configured to: detect an object in a physical environment; and operate the display to output the visual feature at a portion of the display corresponding to the object.
Clause 5: the band is a first band and the head-mountable device further comprises: a second band releasably attached to the frame; and a head engager coupled to the first band and the second band.
Clause 6: the sensor is operably connected to the processor when the frame connector engages the band connector.
Clause 7: the head-mountable device further comprises a camera supported by the frame, wherein the display is configured to output a view captured by the camera.
Clause 8: the activity comprises at least one of an image, a video, or audio.
Clause 9: the activity comprises an activity of the user detected by a sensor.
Clause 10: the band comprises the sensor.
Clause 11: the processor is further configured to cease recording the activity when the head-mountable device leaves a region associated with the band identifier.

As described herein, aspects of the present technology can include the gathering and use of data. The present disclosure contemplates that in some instances, gathered data can include personal information or other data that uniquely identifies or can be used to locate or contact a specific person. The present disclosure contemplates that the entities responsible for the collection, analysis, disclosure, transfer, storage, or other use of such personal information or other data will comply with well-established privacy practices and/or privacy policies. The present disclosure also contemplates embodiments in which users can selectively block the use of or access to personal information or other data (e.g., managed to minimize risks of unintentional or unauthorized access or use).

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A head-mountable device comprising:
a frame;
a camera;
a display for providing a view captured by the camera;
a band releasably attached the frame and configured to secure the frame to a head, the band storing a band identifier; and
a processor configured to:
detect the band identifier; and
operate the display to output a visual feature based on at least one of the band identifier or the view captured by the camera.

2. The head-mountable device of claim 1, wherein:
the frame comprises a frame connector; and
the band comprises a band connector to releasably engage the frame connector, wherein a memory on which the band identifier is stored is operably connected to the processor r when the frame connector engages the band connector.

3. The head-mountable device of claim 2, wherein the band further comprises an electronic circuit, wherein the electronic circuit is operably connected to the processor when the frame connector engages the band connector.

4. The head-mountable device of claim 3, wherein electronic circuit is a sensor operable to detect a condition.

5. The head-mountable device of claim 1, wherein the processor is further configured to:
detect an object in a physical environment; and
operate the display to output the visual feature at a portion of the display corresponding to the object.

6. The head-mountable device of claim 1, wherein the band is a first band and the head-mountable device further comprises:
a second band releasably attached to the frame; and
a head engager coupled to the first band and the second band.

7. A head-mountable device comprising:
a frame;
a display;
a band releasably attached to the frame and configured to secure the frame to a head, the band comprising a sensor and storing a band identifier; and
a processor configured to:
detect the band identifier; and
based on the band identifier, launch an application configured to operate the sensor to detect a condition and output a visual feature on the display.

8. The head-mountable device of claim 7, wherein:
the frame comprises a frame connector; and
the band comprises a band connector to releasably engage the frame connector, wherein a memory on which the band identifier is stored is operably connected to the processor when the frame connector engages the band connector.

9. The head-mountable device of claim 8, wherein the sensor is operably connected to the processor when the frame connector engages the band connector.

10. The head-mountable device of claim 7, wherein the head-mountable device further comprises a camera supported by the frame, wherein the display is configured to output a view captured by the camera.

11. The head-mountable device of claim 10, wherein the processor is further configured to:
detect an object in a physical environment; and
operate the display to output a visual feature based on at least one of the band identifier or the view captured by the camera, the visual feature being at a portion of the display corresponding to the object.

12. The head-mountable device of claim 7, wherein the band is a first band and the head-mountable device further comprises:
a second band releasably attached to the frame; and
a head engager coupled to the first band and the second band.

13. A head-mountable device comprising:
a frame;
a band releasably attached to the frame and configured to secure the frame to head, the band storing a band identifier; and
a processor configured to:
detect the band identifier;
detect a location of the head-mountable device; and
record an activity while the location is within a region associated with the band identifier.

14. The head-mountable device of claim 13, wherein a recording of the activity comprises at least one of an image, a video, or audio.

15. The head-mountable device of claim 13, wherein the activity comprises motion that is detected by a sensor.

16. The head-mountable device of claim 15, wherein the band comprises the sensor.

17. The head-mountable device of claim 13, wherein the head-mountable device further comprises a camera supported by the frame, wherein the display is configured to output a view captured by the camera.

18. The head-mountable device of claim 17, wherein the processor is further configured to:
detect an object in a physical environment; and
operate the display to output a visual feature based on at least one of the band identifier or the view captured by the camera, the visual feature being at a portion of the display corresponding to the object.

19. The head-mountable device of claim 13, wherein the processor is further configured to cease recording the activity when the location is outside the region associated with the band identifier.

20. The head-mountable device of claim 13, wherein the band is a first band and the head-mountable device further comprises:
a second band releasably attached to the frame; and
a head engager coupled to the first band and the second band.
